(19) United States
(12) Patent Application Publication
(10) Pub. No.: US 2002/0109267 A1
(43) Pub. Date: Aug. 15, 2002

(54) Differentiated press-molding process

(76) Inventor: Harald Herbst, Fladnitz (AT)

Correspondence Address: WENDEROTH, LIND & PONACK, L.L.P., 2033 K STREET N. W., SUITE 800, WASHINGTON, DC, 20006-1021, US

(21) Appl. No.: 10/119,811

(22) Filed: Apr. 11, 2002

Related U.S. Application Data
(63) Continuation-in-part of application No. 09/509,096, filed on Mar. 22, 2000.
Application No. 09/509,096 is a 371 of international application No. PCT/EP98/06034, filed on Sep. 22, 1998.

(30) Foreign Application Priority Data
Oct. 2, 1997 (AT) A 1669/97

(51) Int. Cl. B29C 45/00; B29C 43/14

(52) U.S. Cl. 264/328.7; 425/419; 425/412

(57) ABSTRACT

A process for the discontinuous forming of plastics by volume displacement in a cavity, in which process the introduction of forming energy takes place through at least two moved parts of the cavity surface, at least one mold half containing one or more parts moved in relation to it, at least one part of the forming energy being introduced through the relative movement of these parts and only part of the cavity surface being involved in the introduction of the forming energy, as well as a device for carrying out the process and components produced by the process or in the device.

This is a continuation-in-part of Ser. No. 09/509,096, filed Mar. 22, 2000, now abandoned, which is a 371 of PCT/EP98/06034, filed Sep. 22, 1998.

### BACKGROUND OF THE INVENTION

The invention concerns a discontinuous forming process (press-molding process) for plastics based on the working principle of volume displacement in the cavity of a mold by means of a differentiated press-molding process and concerns devices for carrying out the process and components produced by the process or in the device. The press-molding process according to the invention allows a considerable reduction in the necessary high pressing forces occurring in prior-art press-molding processes, in each case, in particular, at the end of the press-molding process, and consequently a corresponding reduction in the structural expenditure for the presses.

In the description of both the prior art and the present invention, use is made of some terms defined as follows:

The term “cavity” used is defined as the space that is variable in its surface and its volume during the molding process, bounded by mold surfaces and by surface areas along which the mold is closed. At the end of the molding process, the cavity formed by the mold is identical to the geometry of the product (component) to be produced. The cavity is usually bounded by surfaces of two mold halves. Additional cavities (for example flow channels), which are important for the molding process but do not belong to the component geometry, are not covered by the term “cavity”.

“Cavity subjected to product” is understood as meaning the part or the partial volume of the cavity which is filled with material to be formed at the respective point in time of the molding process.

The term “surface subjected to product” refers to that surface of the cavity which is in contact with the material to be formed at the respective point in time of the molding process.

The working principle of a forming process (or molding process) by volume displacement comprises exerting pressure on a deformable mass in order to force the latter into a specific shape. The term “introduction of energy into the material to be formed” is understood as meaning the introduction of mechanical energy into the material to be formed in external items of equipment or by corresponding movement of the cavity surfaces subjected to product.

The discontinuous forming of plastics in a cavity starts with the reduction of the cavity and ends at the point in time when the cavity is completely filled with the material to be formed (filling phase). The holding-pressure phase of the molding process, to compensate for shrinkage, is not covered by the term “discontinuous forming of plastics by volume displacement in a cavity”.

Prior-art processes to which the present invention is applicable will be discussed below.

Prior-art press-molding processes refer to those molding processes in which the working principle of volume displacement proceeds directly in the cavity. During closing of the intrinsically rigid mold halves during the molding process, the distance between the two mold halves is reduced, whereby the volume of the cavity is reduced. With the reduction of the mold opening, forming energy is introduced via the surfaces of the cavity subjected to product into the material to be formed.

In prior-art press-molding processes, the entire material mass is introduced into the opened cavity directly before the beginning of the press-molding process. The press-molding process itself begins with the movement of one or both mold halves, the introduction of energy to the material to be formed that is decisive for the molding process taking place via the cavity surface subjected to product. With increasing reduction of the mold opening during the molding process, the cavity surface subjected to product increases in size. The press-molding process is considered to have been completed when the movements of the mold halves come to a standstill, and consequently forming energy is no longer being introduced. During the closing movement of the mold halves, intrinsically movable mold parts of the mold halves which belong to the surface of the cavity, such as ejectors or slides, stay in their basic position, corresponding to the contour, so that the surface contours of the cavity of the two mold halves can be regarded as rigid during the entire press-molding process.

The working principle of volume displacement requires that “material flows” occur during the molding process. The order of magnitude of the material movement or else material stressing during the molding process in press-molding processes likewise allows a differentiation of press-molding processes into a compression-molding process and a flow-molding process.

The compression-molding process is understood as meaning forming into a press-molded part in which the press-molding mass introduced into the opened cavity corresponds in its shape to the greatest extent to the projected surface area of the component contour, as a result of which no great flow paths of the material to be press-molded are necessary during the compression-molding process. In the compression-molding process, the pressing energies introduced by the closing movement of the mold halves are dissipated predominantly in locally restricted plastic material-forming processes and in compression work.

In the prior-art flow-molding process, the entire press-molding mass is introduced into the cavity before the beginning of the press-molding process, the mass of the press-molding material introduced corresponding to the mass of the component. The press-molding process utilizes the flowability of the press-molding material to be press-molded, with the chosen processing parameters (pressure, temperatures, time), in order to fill the cavity. Since, in the flow-molding process, the press-molding mass introduced into the opened cavity is significantly smaller in its shape than the projected surface areas of the component contour, the forming of the material introduced into the mold to produce the component takes place by covering great flow paths.

In a variant of the press-molding process, the transfer-molding process, part of the transfer cylinder surface reaches around part of one mold half. In the transfer-molding process, the volume of material corresponding to the completely closed cavity is placed directly when the mold halves are opened into the cavity additionally formed by the transfer cylinder. Then, the mold halves are closed to the desired extent without introducing forming energy. The decisive introduction of energy into the material to be formed takes place exclusively via the surface subjected to product of the transfer cylinder, which moves as an intrinsically rigid body. The molding process ends with the movement of the transfer cylinder at the point in time at which the geometry of the entire cavity surface is identical to the desired component geometry.

In the injection-stamping process, a special variant of the transfer-molding process, firstly the press-molding material corresponding to the component mass is introduced from outside via flow channels into a not yet entirely closed mold. This takes place by introducing forming energy into the material to be formed in external items of equipment, such as for example by injection-molding machines (injection process). The further forming of the material introduced into the cavity until the final component geometry is obtained takes place according to the prior art with the closing movement of one or both mold halves (stamping operation). The introduction of energy to the material introduced, decisive in the stamping operation, takes place exclusively through the closing movement of the rigid mold halves. During the closing movement of the mold halves, intrinsically movable mold parts of the mold halves which belong to the surface contour of the cavity stay in their basic position corresponding to the contour. The closing operation of the cavities during the stamping operation is a flow-molding process.

In virtually all the processes mentioned above, optimum rheological design of the forming process presents a great difficulty. An optimum rheological design of the forming process is understood as meaning the realization of optimum flow front profiles, flow path lengths and pressure conditions during the filling phase. Defined orientations are often also desired, in particular in the case of fiber-reinforced materials, but can scarcely be achieved with the prior-art press-molding processes. For reasons of manipulation, only a few inserts, usually only one is desired, can be placed into the opened mold cavity and not by any means always at the optimum locations for the flow-molding operation. On account of the preparation of the press-molding material, existing insertion geometries usually constitute a constraint, which makes optimization of the insertion situation even more difficult.

In a press-molding process, complete filling of the cavity with material to be press-molded while maintaining still permissible processing parameters and fixed pressing forces as well as mechanical or hydraulic press capacities of existing machines is often of primary significance. The pressing forces required for closing the mold halves are extremely high toward the end of the flow-molding process, so that very high pressing energies and, in particular, pressing capacities are necessary for complete mold filling. Therefore, presses which are used for the flow-molding process must be dimensioned for their pressing capacity, which is achieved inter alia by the high kinetic energy of the moved mold half being used for increasing the maximum pressing capacity, although this in turn necessitates considerable expenditure on controlling and regulating this energy. Moreover, in the flow-molding process there is a great tendency toward an impending risk of the mold tipping during closing of the mold halves, which can be suppressed only by considerable technical expenditure.

The prior-art discontinuous press-molding process causes an enormous waste of pressing energies and pressing capacities. This is reflected in considerable technical expenditure, in high investment costs for correspondingly large, precision-operating presses and in high energy costs of a press-molding process. Moreover, according to the current state of the art in pressing control, the molding process is to a great extent indifferent in flow-molding processes.

The object of the present invention was to reduce the pressing forces, pressing energies and pressing capacities required during the forming of plastics in the press-molding process, whereby considerable savings in energy and equipment expenditure are made possible. According to the present invention, this is achieved by temporal and locational differentiation of the press-molding process into a number of partial press-molding processes.

### BRIEF SUMMARY OF THE INVENTION

The subject matter of the present invention is, accordingly, a process for the discontinuous forming of plastics by volume displacement in a cavity, in which process the introduction of forming energy into the material to be formed takes place through at least two moved parts of the cavity surface, at least one mold half containing one or more parts moved in relation to it, at least part of the forming energy being introduced through the relative movement of these parts and the introduction of the forming energy taking place in a temporally and locationally differentiated controlled manner, seen over the entire forming process, wherein only part of the cavity surface of at least one mold half, not lying parallel to the direction of movement, is involved in the introduction of the forming energy, seen over the entire forming process.

Each moving part is provided with a single undivided surface for introducing forming energy, which surface is oriented not parallel to the direction of the movement of the moving part.

The movements of the cavity surfaces are preferably controlled in such a way that a standstill of flow fronts is avoided or specifically selected rheological flows and pressure conditions are realized during the molding, which has positive consequences in the achievable component qualities, the possible component designs and the overall process stability of a flow-molding process.

### BRIEF DESCRIPTION OF THE DRAWINGS

FIG. 1 depicts the mold components at the start of the present discontinuous differentiated flow-molding process.

FIG. 2 depicts the mold at an early stage of the present discontinuous differentiated press-molding process.

FIG. 3 depicts the mold at a subsequent step of the present discontinuous differentiated press-molding process.

FIG. 4 depicts the final stage of the present discontinuous differentiated press-molding process.

### DETAILED DESCRIPTION OF THE INVENTION

The embodiments mentioned above relate exclusively to the operating principle of volume displacement within the cavity, independently of whether the entire material to be formed corresponding to the component is in the opened mold cavity before the beginning of the forming process, or else the operating principle of volume displacement within the cavity takes place simultaneously with an external introduction of material to be formed in the cavity. Accordingly, the entire material to be formed may already be in the cavity at the beginning of the forming process. It is also possible, however, that material to be formed is introduced into the cavity from outside during the forming process.

The embodiments mentioned relate both to forming processes in which the material to be formed that is introduced into the cavity has to cover great material movements in the form of flow paths, and to processes in which even small material movements in the form of locally plastic flowing or locally plastic deformations are adequate to fill exactly the geometry of the cavity closed to the desired extent, ensuring molding to produce the desired component.

In a further preferred embodiment of the present invention, the material to be formed that is in the cavity is firstly conveyed by the movement of one mold half partly into a reservoir, which is formed by yielding of a moved part of this cavity surface into a negative relative position, and is subsequently conveyed out of the reservoir into other regions of the cavity by positive relative movement of this moved part of the cavity surface. In this case, during the closing movement of the mold, material to be formed is firstly conveyed into the reservoir which, as mentioned above, is formed by part of the cavity surface yielding, i.e. performing a negative relative movement and thereby reaching a negative relative position, and subsequently moving back in the direction of the cavity, i.e. performing a positive relative movement. This positive relative movement has the effect of conveying the material out of the reservoir into other regions of the cavity. By corresponding positioning and shaping of one or more such reservoirs, it is possible to avoid entirely the high pressing forces toward the end of the pressing operation that are required in prior-art press-molding processes.

The positive relative movement of the moved part of the cavity surface for emptying the reservoir is preferably begun only when all the remaining mold surfaces have at this point in time reached their end position and are not performing any further movements.

With the present invention, the pressing energies, pressing capacities and maximum allowed closing forces required for the forming in the press-molding process can be optimally adapted individually to existing machine sizes, so that mechanical closing and locking systems can also be used, allowing a wide variety of sizes of components to be produced extremely cost-effectively.

The present invention also allows minimizing of the technical expenditure for controlling and regulating devices required by the kinetics of the energies occurring and necessary for suppressing the great tendency of an impending risk of the mold tipping during the press-molding process, which ultimately will drastically reduce the costs of a press-molding device corresponding to the invention.

Further subject matter of the invention is a device for the discontinuous press-molding of plastics in a cavity by the forming process according to the invention, as well as a device for the injection-stamping of plastics in a cavity by the forming process according to the invention, in which devices at least two parts of the cavity surface are movably designed, with at least one mold half containing one or more parts moved in relation to it, in such a way that at least part of the forming energy is introduced into the plastic by the relative movement of these parts. The movable parts of the cavity surfaces are in this case preferably additional presses. Preferred additional presses are, for example, mechanical or hydraulic presses, or ejectors or slides.

A mold which works on the principle of the discontinuous differentiated flow-molding process usually comprises two mold halves. The mold half of the mold on the male-die side is preferably connected either to a hydraulic plunger or to a mechanical locking system and performs the closing movement or opening movement of the press-molding mold. The mold half on the female-die side is in this case fixedly mounted on the press.

One or both mold halves has or have one or more movable parts, which belong to the mold contour and can perform relative movements with respect to their mold halves, it not being stipulated which part of a mold half performs the movement. All the movable parts which belong to the mold contour are referred to as additional presses if they carry out relative movements with respect to their associated mold halves during the forming process, and moreover, by their movement, introduce forming energy into the press-molding material, irrespective of the size of the contour described.

The positive relative position of one additional press with respect to further additional presses of its mold half may exist already at the beginning of the press-molding operation, or else be reached by relative movements during the differentiated flow-molding process. The positive relative position between an additional press and its mold half is used during the cavity filling in the differentiated flow-molding process to the extent that a smaller cavity wall thickness is initially simulated in the contour region of the additional press, which is beneficial for the development of specifically selected flow operations at the beginning of or during the differentiated flow-molding process.

The negative relative position of one additional press with respect to further additional presses of its mold half may exist already at the beginning of the press-molding operation, or else be reached by relative movements during the differentiated flow-molding process. The purpose of a negative relative position between an additional press and its mold half during mold filling in the differentiated flow-molding process is that of creating during the filling phase additional volume in the mold cavity for temporary material reservoirs, since a greater cavity wall thickness is simulated in the contour region of the additional press.

Additional cavities of a corresponding mold which are not part of the mold cavity but are in connection with the latter and via which neither press-molding mass nor energy is introduced into the press-molding mass of the mold cavity subjected to product during the mold-filling operation, may serve to compensate for fluctuations in the inserted press-molding mass.

The main task of an additional press is not to keep the cavity contour rigid during the filling phase of the differentiated flow-molding operation but to form by the possible movements of the additional presses specifically selected volume cavities in the mold cavity, serving as temporary material reservoirs. During the positive relative movement of an additional press, press-molding material is press-molded, the displaced press-molding material on the one hand serving for shaping the corresponding mold cavity and on the other hand, if necessary, for filling one or more further material reservoirs which are formed by the negative relative positions of the respective additional presses. The closing movement of an additional press ends at the position corresponding to the desired component thickness or just above it (shrinkage). The further partial cavities are filled in an analogous way by the positive relative movements of the individual additional presses, it being possible for the individual movements of the additional presses to take place simultaneously, in an overlapping manner or else sequentially. The entire molding of the component in the differentiated flow-molding process is completed when every desired location of the component surface coincides with the surface contour of the mold, and every partial press-molding operation has been completed, which is the case at the beginning of the differentiated flow-molding operation when there is exact mass metering and introduction of the flowable mass to be press-molded into the opened mold cavity. At this point in time, the entire cavity surface is subjected to product.

The force required for the movements and for preserving the static equilibrium of the individual additional presses during the differentiated flow-molding operation may be applied both mechanically and hydraulically. The mechanically performed movements of the additional presses take place via corresponding levers (toggle levers) or spring elements. For instance, it is also quite conceivable for corresponding lifting functions of ejectors or slides integrated in the mold to assume the function of the additional presses. The force required for the individual additional presses may, however, also be applied hydraulically.

The controlling or regulating of the individual movements of the additional presses may take place both in dependence on the travel of the male die and in dependence on the press-molding time. The controlling or regulating of the movements of the additional presses may, however, also take place on the basis of measured mechanical or hydraulic closing forces or else on the basis of internal mold pressures measured at any desired location in the mold cavity.

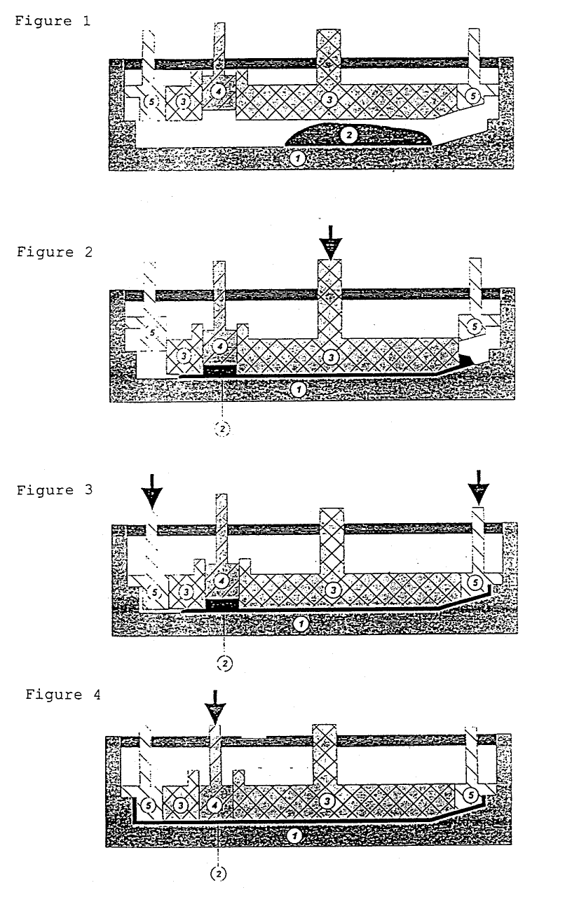

Represented in FIGS. 1 to 4 is a preferred form of the device, that is to say of the mold, used for carrying out the process, in 4 typical positions corresponding to the sequence of the process of the discontinuous differentiated flow-molding process. The mass of press-molding material introduced into the cavity at the beginning of the differentiated press-molding process corresponds to the mass of the component, so that no additional press-molding mass is introduced into the cavity during the differentiated press-molding process. Since, at the beginning of the press-molding process, the surface of the cavity subjected to product is significantly smaller than the overall surface of the cavity at the end of the forming process, the forming takes place for the most part by virtue of the flowability of the press-molding mass, with relatively great flow paths occurring.

FIG. 1 shows the technical mold-related components required for the differentiated flow-molding process and their position at the start of a differentiated flow-molding process. The mold half (1) on the female-die side is of an intrinsically rigid design and is fixedly mounted, its mold surface contours being identical to the corresponding component geometry. Thus, as can be seen from FIG. 1, each moving part is provided with a single undivided surface for introducing forming energy, which surface is oriented not parallel to the direction of the movement of the moving part. The mold half on the male-die side comprises the mold parts (3), (4) and (5), forming movable cavity surfaces. The press-molding material to be press-molded which is introduced into the opened mold cavity and the mass of which corresponds to the desired mass of the component is denoted by (2). Under the chosen process parameters, the press-molding material introduced is in a flowable form.

The force required for the movements and for preserving the required closing forces of the individual moved mold parts may in the embodiment mentioned be applied both mechanically and hydraulically. The individual movements of the old parts (3), (4) and (5) may take place simultaneously, in an overlapping manner or else sequentially, in a controlled manner.

FIG. 2 schematically shows the beginning of the discontinuous differentiated press-molding process. The closing movement of the mold part (3) has the effect that forming energy is introduced into the press-molding material to be formed, resulting in a forming of the press-molding material placed into the press. The closing movement of the mold part (3) in this case ends at the position corresponding to the desired component thickness and stays in this position during the remaining molding in the differentiated press-molding process. The movable mold part (4) fitted into the mold part (3) performs the same closing movement as the moved mold part (3) in this phase of the differentiated press-molding process. The negative relative position of the mold part (4) with respect to the mold part (3) at the beginning of the differentiated press-molding process makes it possible to set up a temporary material reservoir corresponding cavity region of the mold part (4).

The, movable mold part (5) performs no movement in the first phase of the differentiated press-molding process.

The next process phase of the discontinuous differentiated press-molding process is shown in FIG. 3. The closing movement of the movable mold part (5) produces a form fit between the mold half on the male-die side and the mold half on the female-die side, in order to ensure the tightness of the cavity, which is necessary for the complete forming process.

By achieving a correspondingly early tightness of the cavity by the form fit of the movable mold part (5) on the male-die side with the mold part (1) on the female-die side, a positive mold is not necessary. The closing movement of the mold part (5) can, but does not necessarily have to, introduce forming energy into the press-molding material via any surfaces subjected to product. The other movable mold parts (3) and (4) do not perform any movements in this phase of the described sequence of the differentiated press-molding process and consequently do not introduce any forming energy into the press-molding material.

The still remaining forming of the press-molding material to produce the final component in the differentiated press-molding process takes place according to FIG. 4 exclusively by the closing movement of the movable mold part (4) on the male-die side. Consequently, seen over the entire forming process, only part of the cavity surface of at least one mold half, not lying parallel to the direction of movement, is involved in the introduction of the forming energy.

A required holding pressure (shrinkage) is applied by means of additional small closing movements of all the movable mold parts on the male-die side which are not in contact with the mold half on the female-die side via a direct form fit.

Both the size and shape of the individual movable mold parts on the male-die side can be individually adapted for technical mold-related reasons and on account of rheological conditions and are thus capable of being operated individually. The individual sequences of movements of the moved mold parts on the male-die side may be additionally controlled individually. This situation opens up considerable scope for finding the ideal molding process in a discontinuous differentiated press-molding process. In this sense, the closing phases described here of the strictly sequential order of the sequences of movements will take place in practice in simultaneously proceeding closing movements of the individual movable mold parts. In the sense of the present invention, however, it corresponds to a preferred embodiment of the discontinuous differentiated press-molding process that the final phases of the forming process, that is to say complete mold filling, take place by introducing forming energy via those cavity surfaces of the movable mold parts which have the smallest cavity surfaces.

The process and the device according to the invention are suitable for press-molding all plastics capable of being press-molded, in particular those which are plastic or flowable under press-molding conditions. Preferred are thermosetting or thermoplastic materials, such as for example urea, melamine or phenolic resins, epoxies, polyolefins, such as for example polyethylene, or polypropylene, polyamides, polyimides, polyesters, polyether ketones, polyester ketones, polysulfides, polysulfones or aramids. The plastics mentioned may be both unfilled, filled or used with the addition of customary additives. The process and the device according to the invention are also suitable for the press-molding of metals and ceramic materials.

Further subject matter of the invention are components made of plastics which are produced by the process according to the invention, or components which are produced in the device according to the invention. Such components are, for example: machine parts and components of the automotive industry, for example car bodies, doors, engine hoods, fenders, tailgates, roofs, side sills, bumper brackets, engine capsules, spare wheel recesses, front ends, battery holders, underfloor panels, dashboards, seat shells, interior trim and exterior panels for automobiles, motorcycle fairings, etc.; machine parts and components in aerospace and shipping; structural components, seat shells, baggage racks, panels, transport containers, etc.; components of the electrical and electronics industries: housing parts, coverings, domestic appliances, switch cabinets, lamp housings, housings and structural components of the computer industry, support structures for electronic components, etc.; components of the construction industry, the furniture industry and the household industry: and shower cubicles, swimming pools, bath tubs, wash basins, chemical containers and chemical equipment, gullies, containers, trays, eating utensils, facade structures, garden benches, roof domes, tool housings, transport containers, semifinished product manufacture, etc.

What is claimed is:

1. A process for the discontinuous forming of plastics by volume displacement in a cavity, in which process the introduction of forming energy into the material to be formed takes place through at least two moved parts of the cavity surface, at least one mold half containing one or more parts moved in relation to it, at least part of the forming energy being introduced through relative movement of these parts and the introduction of the forming energy taking place in a temporally and locationally differentiated controlled manner, seen over the entire forming process, wherein only part of the overall cavity surface of at least one mold half, not lying parallel to the direction of movement, is involved in the introduction of the forming energy, seen over the entire forming process and where each of the moving parts is being operated individually and where each moving part is provided with a single undivided surface for introducing forming energy, which surface is oriented not parallel to the direction of the movement of the moving part.

2. The process as claimed in claim 1, wherein the entire material to be formed is already in the cavity at the beginning of the forming process.

3. The process as claimed in claim 1, wherein material to be formed is introduced into the cavity from outside during the forming process.

4. The process as claimed in claim 1, wherein material to be formed that is in the cavity is firstly conveyed by the movement of one mold half partly into a reservoir, which is formed by yielding of a moved part of the cavity surface into a negative relative position, and is subsequently conveyed out of the reservoir into other regions of the cavity by positive relative movement of this moved part of the cavity surface.

5. The process as claimed in claim 1, wherein great flow paths of the material occur during the forming process.

6. The process as claimed in claim 1, wherein the forming takes place by local plastic flowing.

7. A device for the discontinuous press-molding of plastics in a cavity comprising two mold halves, wherein at least two parts of the cavity surface are movably designed, with at least one mold half containing one or more parts movable in relation to it, in such a way that at least part of the forming energy is introduced into the plastic by the relative movement of these parts and where the movable parts are being operable individually and where each of the movable parts is provided with a single undivided surface for introducing forming energy, which surface is oriented not parallel to the direction of the movement of the movable part.

8. The device for the injection-stamping of plastics in a cavity as claimed in claim 1, wherein at least two parts of the cavity surface are movably designed, with at least one mold half containing one or more parts moved in relation to it, in such a way that at least part of the forming energy is introduced into the plastic by the relative movement of these parts, and where each of the movable parts is provided with a single undivided surface for introducing forming energy, which surface is oriented not parallel to the direction of the movement of the movable part.

9. The device as claimed in claim 7, wherein the movable parts are designed as additional presses.

10. The device as claimed in claim 8, wherein the movable parts are designed as additional presses.

11. The device as claimed in claim 9, wherein the additional presses are formed by hydraulic presses.

12. The device as claimed in claim 10, wherein the additional presses are formed by hydraulic presses.

13. The device as claimed in claim 9, wherein the additional presses are formed by mechanical presses.

14. The device as claimed in claim 10, wherein the additional presses are formed by mechanical presses.

15. The device as claimed in claim 9, wherein the additional presses are formed by ejectors or slides.

16. The device as claimed in claim 10, wherein the additional presses are formed by ejectors or slides.

17. Components made of plastic, wherein they are produced by a process as claimed in claim 1.

18. Components made of plastic, wherein they are produced by a process as claimed in claim 2.

19. Components made of plastic, wherein they are produced by a process as claimed in claim 3.

20. Components made of plastic, wherein they are produced by a process as claimed in claim 4.

21. Components made of plastic, wherein they are produced by a process as claimed in claim 5.

22. Components made of plastic, wherein they are produced by a process as claimed in claim 6.

23. Components made of plastic, wherein they are produced in a device as claimed in claim 7.

24. Components made of plastic, wherein they are produced in a device as claimed in claim 8.

25. Components made of plastic, wherein they are produced in a device as claimed in claim 9.

26. Components made of plastic, wherein they are produced in a device as claimed in claim 10.

27. Components made of plastic, wherein they are produced in a device as claimed in claim 11.

28. Components made of plastic, wherein they are produced in a device as claimed in claim 12.

29. Components made of plastic, wherein they are produced in a device as claimed in claim 13.

30. Components made of plastic, wherein they are produced in a device as claimed in claim 14.

31. Components made of plastic, wherein they are produced in a device as claimed in claim 15.

32. Components made of plastic, wherein they are produced in a device as claimed in claim 16.
